(19) United States
(12) Patent Application Publication
(10) Pub. No.: US 2018/0358043 A1
(43) Pub. Date: Dec. 13, 2018

(54) MAGNETIC RECORDING MEDIUM

(71) Applicant: FUJIFILM Corporation, Tokyo (JP)

(72) Inventors: Kenji NAOI, Kanagawa (JP); Takashi FUJIMOTO, Kanagawa (JP); Masashi SHIRATA, Kanagawa (JP)

(73) Assignee: FUJIFILM Corporation, Tokyo (JP)

(21) Appl. No.: 15/986,882

(22) Filed: May 23, 2018

(30) Foreign Application Priority Data
Jun. 9, 2017 (JP) 2017-114790

(51) Int. Cl. G11B 5/706

(52) U.S. Cl. CPC G11B 5/70615

(57) ABSTRACT

A magnetic recording medium includes: a non-magnetic support; and a magnetic layer including a binding agent and a ferromagnetic powder including at least one epsilon-type iron oxide compound selected from the group consisting of ε-Fe₂O₃ and compound represented by Formula (1) (A represents at least one metal element other than Fe, and a satisfies 0<a<2), in which a value of magnetic field Hc with respect to magnetic field Hc′ is from 0.6 to 1.0, and Hc′ satisfies Expression (II): 119 kA/m<Hc′<2380 kA/m. The magnetic field Hc′ is a magnetic field when the value of Expression (I): d²M/dH² is zero, wherein a magnetization M, which is obtained by a magnetic field-magnetization curve obtained by measurement under specific conditions, is subjected to second derivative with respect to an applied magnetic field H, and magnetic field Hc is a magnetic field when the magnetization is zero in the curve.

ε-AₐFe₂₋ₐO₃ (1)

### CROSS-REFERENCE TO RELATED APPLICATIONS

This application claims priority under 35 USC 119 from Japanese Patent Application No. 2017-114790 filed on Jun. 9, 2017, the disclosure of which is incorporated by reference herein in its entirety.

### BACKGROUND OF THE INVENTION

### 1. Field of the Invention

The present invention relates to a magnetic recording medium.

### 2. Description of the Related Art

Epsilon-type iron oxide (ε-Fe₂O₃) is drawing an attention as a magnetic material due to coercivity which is three times the coercivity of a ferrite magnet. In regards to this, an attempt for improving magnetic properties of a magnetic material including ε-Fe₂O₃ (a part of the Fe site includes a compound substituted with other metal elements) has been made.

For example, there is disclosed magnetic powder which are formed of particles of iron oxide including ε-Fe₂O₃ crystal (a part of the Fe site includes a compound substituted with a metal element M) as a main phase, and in which an average particle diameter of particle diameters measured with a transmission electron microscope (TEM) image is 10 nm to 200 nm and a number percentage of particles having a particle diameter smaller than 10 nm is equal to or smaller than 25% (for example, see JP5130534B).

In addition, for example, there is disclosed iron-based oxide magnetic particle powder having predetermined magnetic properties, in which an average particle diameter is 10 nm to 30 nm, and a part of the Fe site of ε-Fe₂O₃ is substituted with other metal elements (for example, see JP5966064B).

### SUMMARY OF THE INVENTION

JP5130534B discloses that the magnetic material has high coercivity and JP5966064B discloses that the magnetic material has a narrow coercivity distribution. However, in a case of manufacturing a magnetic recording medium, not only excellent magnetic properties of a magnetic material, but also physical properties such as excellent film hardness of a magnetic layer are important, for example, from a viewpoint of running durability or the like. In regards to this, according to studies of the inventors, it is determined that magnetic recording media of JP5130534B and JP5966064B including magnetic materials in magnetic layers have insufficient film hardness of the magnetic layers.

In these circumstances, an object of one embodiment of the invention is to provide a magnetic recording medium having excellent electromagnetic conversion characteristics and film hardness of a magnetic layer.

Specific means for achieving the aforementioned object include the following aspects.

<1> A magnetic recording medium, including:

a non-magnetic support; and

a magnetic layer that is provided on the non-magnetic support and that includes a ferromagnetic powder and a binding agent, the ferromagnetic powder including at least one epsilon-type iron oxide compound selected from the group consisting of ε-Fe₂O₃ and a compound represented by the following Formula (1),

in which a value of a magnetic field Hc with respect to a magnetic field Hc′ is from 0.6 to 1.0, and Hc′ satisfies the following Expression (II),

in which the magnetic field Hc′ is a magnetic field when the value of the following Expression (I) is zero, wherein a magnetization M, which is obtained by a magnetic field-magnetization curve obtained by measurement at a maximum applied magnetic field of 359 kA/m, a temperature of 296 K, and a magnetic field sweeping speed of 1.994 kA/m/s, is subjected to a second derivative with respect to an applied magnetic field H, and in which the magnetic field Hc is a magnetic field when the magnetization is zero in the magnetic field-magnetization curve.

d²M/dH² Expression (I)

119 kA/m<Hc′<2380 kA/m Expression (II)

ε-AₐFe₂₋ₐO₃ (1)

In Formula (1), A represents at least one metal element other than Fe, and a satisfies a relationship of 0<a<2.

<2> The magnetic recording medium according to <1>, in which the binding agent includes a binding agent having a crosslinked structure.

<3> The magnetic recording medium according to <1> or <2>, in which a value of Hc with respect to Hc′ is from 0.65 to 1.0.

<4> The magnetic recording medium according to any one of <1> to <3>, in which a value of Hc with respect to Hc′ is from 0.71 to 1.0.

<5> The magnetic recording medium according to any one of <1> to <4>, in which a content of the binding agent is 5 parts by mass to 30 parts by mass with respect to 100 parts by mass of the ferromagnetic powder.

<6> The magnetic recording medium according to any one of <1> to <5>, in which a mass ratio of mass of a nonvolatile component with respect to mass of the ferromagnetic powder in the magnetic layer is from 0.15 to 1.8.

<7> The magnetic recording medium according to any one of <1> to <6>, in which a thickness of the magnetic layer is 10 nm to 350 nm.

<8> The magnetic recording medium according to any one of <1> to <7>, in which A in Formula (1) is at least one metal element selected from the group consisting of Ga, Al, In, Nb, Co, Zn, Ni, Mn, Ti, and Sn.

<9> The magnetic recording medium according to <8>, in which a compound represented by Formula (1) includes Ga, and an atomic composition percentage of Ga atoms is 5 atom % to 50 atom % with respect to Fe atoms.

According to this disclosure, it is possible to provide a magnetic recording medium having excellent electromagnetic conversion characteristics and film hardness of a magnetic layer.

### DESCRIPTION OF THE PREFERRED EMBODIMENTS

In this disclosure, a numerical value range shown with “to” means a range including numerical values written before and after “to”, respectively as the minimum value and the maximum value. In the numerical value range disclosed in a stepwise manner in this disclosure, an upper limit value or a lower limit value disclosed in a certain numerical value range may be replaced with an upper limit value or a lower limit value of another numerical value range disclosed in a stepwise manner. In addition, in the numerical value range disclosed in this disclosure, an upper limit value or a lower limit value disclosed in a certain numerical value range may be replaced with values shown in examples.

In this disclosure, in a case where a plurality of substances corresponding to components are present in a composition, the amount of each component in the composition means a content of the plurality of substances present in the composition, unless otherwise noted.

In this disclosure, a term “step” not only means an independent step, but also includes a step, as long as the intended object of the step is achieved, even in a case where the step cannot be clearly distinguished from another step.

A “solvent” in this disclosure is used as a meaning including water, an organic solvent, and a mixed solvent of water and an organic solvent.

Magnetic Recording Medium

A magnetic recording medium of this disclosure includes: a non-magnetic support; and a magnetic layer that is provided on the non-magnetic support and that includes a ferromagnetic powder and a binding agent, the ferromagnetic powder including at least one epsilon-type iron oxide compound selected from the group consisting of ε-Fe₂O₃ and a compound represented by Formula (1), in which a value of a magnetic field Hc with respect to a magnetic field Hc′ is from 0.6 to 1.0, and Hc′ satisfies Expression (II), in which the magnetic field Hc′ is a magnetic field when the value of the following Expression (I) is zero, wherein a magnetization M, which is obtained by a magnetic field-magnetization curve obtained by measurement at a maximum applied magnetic field of 359 kA/m, a temperature of 296 K, and a magnetic field sweeping speed of 1.994 kA/m/s, is subjected to a second derivative with respect to an applied magnetic field H, and in which the magnetic field Hc is a magnetic field when the magnetization is zero in the magnetic field-magnetization curve.

d²M/dH² Expression (I)

119 kA/m<Hc′<2380 kA/m Expression (II)

ε-AₐFe₂₋ₐO₃ (1)

In Formula (1), A represents at least one metal element other than Fe, and a satisfies a relationship of 0<a<2.

In related art, an attempt for improving magnetic properties of a magnetic material including ε-Fe₂O₃ (a part of the Fe site includes a compound substituted with other metal elements) had been made. However, in a case of manufacturing a magnetic recording medium, not only excellent magnetic properties of a magnetic material, but also excellent physical properties such as film hardness of a magnetic layer are important, for example, from a viewpoint of running durability or the like. In regards to this, it is determined that magnetic recording media including ε-Fe₂O₃ disclosed in JP5130534B and JP5966064B in magnetic layers have insufficient film hardness of the magnetic layers.

With respect to this, in this disclosure, a magnetic recording medium having excellent electromagnetic conversion characteristics and film hardness of a magnetic layer is provided by setting Hc/Hc′ which will be specifically described below to be 0.6 to 1.0.

The details are not clear but the assumption is made as follows. That is, in the magnetic recording medium of this disclosure, it is thought that, by setting Hc/Hc′ to be 0.6 to 1.0, the amount of superparamagnetic components in the magnetic layer of the magnetic recording medium decreases, thereby improving electromagnetic conversion characteristics of the magnetic recording medium.

As such superparamagnetic components, ultrafine ferromagnetic powder particles having significantly deteriorated magnetic properties due to a primary particle diameter smaller than 10 nm (for example, equal to or smaller than 5 nm) are considered. Such ultrafine ferromagnetic powder particles have a larger surface area per unit volume, compared to that of ferromagnetic powder particles having a great primary particle diameter. In addition, it is thought that, in a case where Hc/Hc′ of the magnetic recording medium is smaller than 0.6, a large amount of such ultrafine particles is present in the magnetic layer, accordingly, the amount of the binding agent sufficient for forming a film on the magnetic layer cannot be ensured, with respect to the ferromagnetic powder having a large surface area, and film hardness of the magnetic layer of the magnetic recording medium is deteriorated. However, in this disclosure, it is thought that, by setting Hc/Hc′ of the magnetic recording medium to be 0.6 to 1.0, the amount of superparamagnetic components such as ultrafine ferromagnetic powder particles decreases in the magnetic layer of the magnetic recording medium, the amount of the binding agent sufficient for forming a film on the magnetic layer is ensured with respect to the ferromagnetic powder, and a magnetic recording medium having excellent film hardness of the magnetic layer is formed.

In this disclosure, it is determined that, by controlling the following physical properties obtained from a magnetic field-magnetization curve, it is possible to provide a magnetic recording medium having excellent electromagnetic conversion characteristics and film hardness of a magnetic layer.

Specifically, in the magnetic recording medium, a value of a magnetic field Hc with respect to a magnetic field Hc′ is from 0.6 to 1.0, and Hc′ satisfies the following Expression (II), in which the magnetic field Hc′ is a magnetic field when the value of the following Expression (I) is zero, wherein a magnetization M, which is obtained by a magnetic field-magnetization curve obtained by measurement at a maximum applied magnetic field of 359 kA/m, a temperature of 296 K, and a magnetic field sweeping speed of 1.994 kA/m/s, is subjected to a second derivative with respect to an applied magnetic field H, and in which the magnetic field Hc is a magnetic field when the magnetization is zero in the magnetic field-magnetization curve.

d²M/dH² Expression (I)

119 kA/m<Hc′<2380 kA/m Expression (II)

In this disclosure, the value of Hc with respect to Hc′ may be referred to as “Hc/Hc′”.

(Hc/Hc′)

A method of obtaining Hc/Hc′ of this disclosure will be described specifically.

Regarding the magnetic recording medium, an intensity of magnetization with respect to a magnetic field, to which magnetization is applied at a maximum applied magnetic field of 359 kA/m, a temperature of 296 K, and a magnetic field sweeping speed of 1.994 kA/m/s, is measured by using an oscillation sample type magnetic-flux meter (TM-TRVSM5050-SMSL type) manufactured by Tamakawa Co., Ltd. With the measurement results, a magnetic field (H)-magnetization (M) curve is obtained.

A magnetic field in which a value of Expression (I) obtained by second derivative of magnetization M with respect to an applied magnetic field H, becomes zero is calculated based on the obtained magnetic field (H)-magnetization (M) curve, and this is defined as Hc′. Hc′ satisfies Expression (II).

d²M/dH² Expression (I)

119 kA/m<Hc′<2380 kA/m Expression (II)

The value (Hc′) of the magnetic field in which the value of Expression (I) becomes zero is equivalent to a value of a magnetic field in a case where a value (dM/dH) obtained by differentiation of the magnetization M with respect to the applied magnetic field H becomes a maximum.

In addition, in the obtained magnetic field (H)-magnetization (M) curve, the value of the magnetic field H in which the magnetization M becomes zero is defined as Hc. Hc is a value indicating coercivity of magnetic powder which is a measurement target.

A ratio (Hc/Hc′) of the value of the magnetic field in which the magnetization becomes zero (Hc) with respect to the value of the magnetic field in which the value of Expression (I) obtained here becomes zero (Hc′) is acquired.

Hc/Hc′ indicates a ratio of a magnetization reversal magnetic field in a case of being affected by superparamagnetic components and a magnetization reversal magnetic field in a case of not being affected by superparamagnetic components, and is a parameter indirectly showing the amount of superparamagnetic components. As the value of Hc/Hc′ is high, the amount of superparamagnetic components decreases, and as the value of Hc/Hc′ is low, the amount of superparamagnetic components increases. The theoretical upper limit value of Hc/Hc′ is 1.0.

In the magnetic recording medium of this disclosure, Hc/Hc′ is 0.6 to 1.0, preferably 0.65 to 1.0, more preferably 0.71 to 1.0, and even more preferably 0.90 to 1.0. Hc/Hc′ of the magnetic recording medium is 0.6 to 1.0 and preferably 0.65 to 1.0, and thus, electromagnetic conversion characteristics of the magnetic recording medium and film hardness of the magnetic layer become excellent. In addition, by setting Hc/Hc′ of the magnetic recording medium to be 0.71 to 1.0, particularly excellent film hardness of the magnetic layer of the magnetic recording medium is obtained. Further, by setting Hc/Hc′ of the magnetic recording medium to be 0.90 to 1.0, particularly excellent electromagnetic conversion characteristics of the magnetic recording medium are obtained. The theoretical upper limit value of Hc/Hc′ is 1.0. Hc/Hc′ of the magnetic recording medium is preferably equal to or smaller than 0.95.

In order to adjust Hc/Hc′ of the magnetic recording medium to be 0.6 to 1.0, the following procedure can be used, for example, but there is no limitation to the following procedure.

100 parts by mass of a metal raw material and 0 parts by mass to 50 parts by mass of a water-soluble polymer compound A are dissolved in 200 parts by mass or more of water, an alkali aqueous solution A is added thereto and stirred, an acid aqueous solution is added and stirred, the generated precipitate is collected by centrifugal separation, and the precipitate is washed with water and dried.

A dispersion liquid obtained by adding and dispersing the powder obtained as described above in water is heated to 2° C. to 80° C., an alkali aqueous solution B is added dropwise while stirring the dispersion liquid, and then, metalalkoxide acting with a matrix at the time of firing is added and stirred. Salts (for example, ammonium sulfate) are added into this solution as a precipitating agent, a precipitated powder is collected by centrifugal separation, washed with water, and dried, thereby obtaining powder of a precursor compound (precursor powder) of an epsilon-type iron oxide-based compound. A firing furnace is filled with the obtained precursor powder, and heat treatment is performed at 900° C. to 1,200° C. for 1 hour to 30 hours, thereby obtaining heat-treated powder. This heat-treated powder is put into a sodium hydroxide aqueous solution having a concentration of 0.5 mol/L to 10 mol/L at 20° C. to 90° C. and stirred for 2 hours to 80 hours. The precipitate generated by doing so is collected by centrifugal separation and washed with pure water, thereby obtaining ferromagnetic powder A.

Preferably, the ferromagnetic powder A obtained by the above procedure is further dispersed in an aqueous solution under the presence of 0.5% by mass to 25% by mass of a water-soluble polymer compound B, and a precipitate obtained by performing centrifugal treatment of this dispersion liquid with a centrifugal force of 100,000 m/s² to 3,000,000 m/s² for 5 minutes to 120 minutes, is washed and dried, thereby obtaining ferromagnetic powder B.

The magnetic recording medium can be manufactured by using the ferromagnetic powder A or the ferromagnetic powder B. The magnetic recording medium can be, for example, manufactured by a manufacturing method of a magnetic recording medium which will be described later.

In the procedure for adjusting Hc/Hc′ of magnetic recording medium to be 0.6 to 1.0, the kinds of metals and a composition ratio of metals of the metal raw material can be suitably set based on a metal composition of a desired epsilon-type iron oxide-based compound. For the metal composition, the description in the section of “Epsilon Type Iron Oxide-Based Compound” which will be described later can be referred to.

The metal raw material may be water-soluble metal salt (including hydrate), and for example, nitrate or sulfate is preferable.

In the procedure for adjusting Hc/Hc′ of magnetic recording medium to be 0.6 to 1.0, the water-soluble polymer compound A functions as a dispersant of the metal raw material and can preferably control a size or dispersibility of the precursor powder. Accordingly, it is thought that Hc/Hc′ in a case where a magnetic recording medium is obtained is improved (becomes equal to or greater than 0.6). As the water-soluble polymer compound A, polyvinylpyrrolidone (PVP), polyvinyl alcohol (PVA), or a combination of PVP and PVA is preferable. The content of the water-soluble polymer compound A is preferably 1 part by mass to 20 parts by mass and more preferably 5 parts by mass to 15 parts by mass with respect to 100 parts by mass of the metal raw material.

In the procedure for adjusting Hc/Hc′ of magnetic recording medium to be 0.6 to 1.0, metal alkoxide is not particularly limited, as long as it includes an alkoxy group directly bonded to a metal atom and is a compound capable of being subjected to condensation polymerization. The metal alkoxide is preferably a compound including a group in which two or more alkoxy groups are directly bonded to a metal atom.

The metal atom of the metal alkoxide includes an atom of an element classified as a metal, an atom of an element classified as a semimetal (for example, silicon or boron), and an atom showing metallic properties in a case of being bonded to an alkoxy group, although it is an atom of an element classified as a non-metal (for example, phosphorus). Examples of the metal atom include silicon (Si), titanium (Ti), zirconium (Zr), aluminum (Al), boron (B), phosphorus (P), zinc (Zn), magnesium (Mg), germanium (Ge), gallium (Ga), antimony (Sb), tin (Sn), tantalum (Ta), and vanadium (V).

The metal alkoxide is preferably metal alkoxide including silicon.

Examples of a metal alkoxide compound including silicon include tetramethoxy silane, tetraethoxy silane (TEOS), tetrapropoxy silane, trimethoxy silane, triethoxysilane, tripropoxy silane, methyltrimethoxy silane, methyltrimethoxy silane, methyltriethoxy silane, ethyltrimethoxy silane, ethyltriethoxy silane, propyltrimethoxy silane, propyltriethoxy silane, dimethyldimethoxy silane, dimethyldiethoxy silane, diethyldimethoxy silane, diethyldiethoxy silane, γ-chloropropyltrimethoxy silane, γ-chloropropyltriethoxy silane, phenyltrimethoxy silane, phenyltriethoxy silane, diphenyldimethoxy silane, and diphenyldiethoxy silane, and tetraethoxy silane is preferable.

Examples of a metal alkoxide compound including titanium include tetramethoxy titanium, tetraethoxy titanium, tetrapropoxy titanium, tetraisopropoxy titanium, tetrabutoxy titanium, tetra-sec-butoxy titanium, and tetra-tert-butoxy titanium.

Examples of a metal alkoxide compound including zirconium include tetramethoxy zirconium, tetraethoxy zirconium, tetrapropoxy zirconium, tetraisopropoxy zirconium, tetrabutoxy zirconium, tetra-sec-butoxy zirconium, and tetra-tert-butoxy zirconium.

Examples of a metal alkoxide compound including aluminum include trimethoxy aluminum, triethoxy aluminum, tripropoxy aluminum, triisopropoxy aluminum, tributoxy aluminum, tri-sec-butoxy aluminum, and tri-tert-butoxy aluminum.

Examples of a metal alkoxide compound including boron include trimethoxy borane, triethoxy borane, tripropoxy borane, triisopropoxy borane, tributoxy borane, tri-sec-butoxy borane, and tri-tert-butoxy borane.

Examples of a metal alkoxide compound including phosphorus include Trimethoxy phosphine and triethoxy phosphine.

Examples of a metal alkoxide compound including zinc include dimethoxy zinc and diethoxy zinc.

Examples of a metal alkoxide compound including magnesium include dimethoxy magnesium and diethoxy magnesium.

Examples of a metal alkoxide compound including germanium include tetraethoxy germanium and tetra-n-propoxy germanium.

Examples of a metal alkoxide compound including gallium include triethoxy gallium and tri-n-butoxy gallium.

Examples of a metal alkoxide compound including antimony include triethoxy antimony and tri-n-butoxy antimony.

Examples of a metal alkoxide compound including tin include tetraethoxy tin and tetra-n-propoxy tin.

Examples of a metal alkoxide compound including tantalum include pentamethoxytantalum and pentaethoxytantalum.

In the procedure for adjusting Hc/Hc′ of magnetic recording medium to be 0.6 to 1.0, the alkali aqueous solution A and the alkali aqueous solution B are preferably aqueous solutions having pH which is greater than 7 and equal to or smaller than 14, more preferably, ammonia aqueous solutions, and even more preferably ammonia aqueous solutions having a concentration of 10% by mass to 30% by mass.

In the procedure for adjusting Hc/Hc′ of magnetic recording medium to be 0.6 to 1.0, the acid aqueous solution is preferably an aqueous solution having pH which is equal to or greater than 1 and smaller than 7, more preferably a citric acid aqueous solution, and even more preferably citric acid aqueous solution having a concentration of 1% by mass to 20% by mass.

In the procedure for adjusting Hc/Hc′ of magnetic recording medium to be 0.6 to 1.0, the water-soluble polymer compound B is preferably polyvinyl alcohol (PVA), polyvinylpyrrolidone (PVP), or a combination of PVA and PVP. By dispersing the ferromagnetic powder A in the water-soluble polymer compound B, dispersibility with respect to a solvent is improved.

In the procedure for adjusting Hc/Hc′ of magnetic recording medium to be 0.6 to 1.0, the conditions for performing the centrifugal treatment of the dispersion liquid of the ferromagnetic powder A are preferably a centrifugal force of 1961330 m/s² and a period of time of 20 minutes to 30 minutes. By performing centrifugal separation with a centrifugal force of 1961330 m/s² for 20 minutes to 30 minutes, the amount of ultrafine ferromagnetic powder particles (for example, a primary particle diameter equal to or smaller than 5 nm) included in the precipitate decreases, thereby further improving film hardness of the magnetic layer, in a case where a magnetic recording medium is manufactured.

In the magnetic recording medium, the magnetic layer can be provided on at least one surface of the non-magnetic support, and is preferably provided on one surface of the non-magnetic support. Examples of magnetic recording medium may include other layers according to the purpose. As the other layers which can be included in the magnetic recording medium, a non-magnetic layer, a back coating layer, and the like. The other layers will be described later.

Non-Magnetic Support

The magnetic recording medium of this disclosure includes a non-magnetic support. The non-magnetic support indicates a support not having magnetism. Hereinafter, the non-magnetic support may be simply referred to as a “support”.

Here, the “non-magnetic” state indicates a state where a residual magnetic flux density is equal to or smaller than 10 mT, a state where coercivity is equal to or smaller than 7.98 kA/m (100 Oe), or a state where a residual magnetic flux density is equal to or smaller than 10 mT and coercivity is equal to or smaller than 7.98 kA/m (100 Oe), and preferably means that neither residual magnetic flux density nor coercivity is obtained.

As the non-magnetic support, a base material formed by a material not having magnetism, for example, materials such as a resin material not including a magnetic material, an inorganic material not having magnetism, and the like can be used. The material used for forming the non-magnetic support can be suitably selected from materials satisfying requirements such as physical properties such as formability necessary for a magnetic recording medium or durability of the formed non-magnetic support.

The non-magnetic support is selected according to the usage aspect of the magnetic recording medium. For example, in a case where the magnetic recording medium is a magnetic tape, a flexible disk, or the like, a resin film having flexibility can be used as the non-magnetic support. In a case where the magnetic recording medium is a hard disk or the like, a resin formed body, an inorganic material formed body, or a metal material formed body which has a disk shape and is harder than the support for a flexible disk, can be used as the non-magnetic support.

Examples of the resin material used for forming the non-magnetic support include a resin material such as polyester such as polyethylene terephthalate (PET) or polyethylene naphthalate (PEN), polyolefin such as polyethylene or polypropylene, an amide-based resin such as aromatic polyamide including polyamide, polyamide imide, or polyaramide, polyimide, cellulose triacetate (TAC), polycarbonate (PC), polysulfone, and polybenzoxazole. It is possible to form the non-magnetic support by suitably selecting the resin material from the resin materials described above.

Among these, from viewpoints of excellent hardness and durability and ease of processing, polyester and an amide-based resin are preferable, Polyethylene terephthalate, polyethylene naphthalate, and polyamide are more preferable.

In a case of using the resin material in the non-magnetic support such as a magnetic tape, the resin material is formed in a film shape. As a method of forming the resin material in a film shape, a well-known method can be used.

A resin film may be an unstretched film or may be a uniaxially stretched film or a biaxially stretched film. For example, in a case of using polyester, a biaxially stretched polyester film can be used, in order to improve dimensional stability.

In addition, a film having a laminated structure of two or more layers can also be used, according to the purpose. That is, as disclosed in JP1991-224127A (JP-H03-224127A), for example, a non-magnetic support obtained by laminating a film including two different layers can also be used, in order to change surface roughness of a surface on which a magnetic layer is formed and a surface on which a magnetic layer is not formed.

In a case where the magnetic recording medium is a hard disk, a resin formed body obtained by forming the resin material described above in a disk shape, or an inorganic material formed body obtained by forming an inorganic material such as glass or a metal material such as aluminum in a disk shape can be used as the non-magnetic support.

For example, in order to improve adhesiveness with the magnetic layer to be provided on the surface of the non-magnetic support, surface treatment such as corona discharge, plasma treatment, easy bonding treatment, or heat treatment may be performed with respect to the non-magnetic support in advance, if necessary. In addition, in order to prevent foreign materials from mixing into the magnetic layer, surface treatment such as dust protection treatment may be performed with respect to the non-magnetic support.

Each surface treatment described above can be performed by a well-known method.

A thickness of the non-magnetic support is not particularly limited and can be suitably set according to the use of the magnetic recording medium. The thickness of the non-magnetic support is preferably 3.0 μm to 80.0 μm. For example, in a case where the magnetic recording medium is a magnetic tape, the thickness of the non-magnetic support is preferably 3.0 μm to 6.5 μm, more preferably 3.0 μm to 6.0 μm, and even more preferably 4.0 μm to 5.5 μm.

The thicknesses of the non-magnetic support and each layer of the magnetic recording medium which will be described later can be acquired by exposing a cross section of the magnetic recording medium in a thickness direction by a well-known method such as ion beams or a microtome, performing cross section observation regarding the exposed cross section with a scanning electron microscope, and obtaining a thickness of a portion in a thickness direction in the cross section observation or obtaining an arithmetical mean of thicknesses obtained in randomly extracted two or more of plural portions (for example, two portions).

Magnetic Layer

The magnetic layer is a layer contributing to magnetic recording. The magnetic layer includes ferromagnetic powder as a magnetic material, and a binding agent which is a film forming component, and may further include additives, according to the purpose. The magnetic layer preferably includes a binding agent having a crosslinked structure, which is formed by reacting with a curing agent. Since the magnetic layer includes a binding agent having a crosslinked structure, film hardness of the magnetic layer is improved.

Ferromagnetic Powder

The ferromagnetic powder is powder including at least one kind of epsilon-type iron oxide-based compound selected from the group consisting of ε-Fe₂O₃ and a compound represented by Formula (1).

ε-AₐFe₂₋ₐO₃ (1)

In Formula (1), A represents at least one metal element other than Fe, and a satisfies a relationship of 0<a<2. a preferably satisfies a relationship of 0<a<1.8 and more preferably satisfies a relationship of 0.1<a<1.2, from viewpoints of magnetic properties and stable forming of an ε phase.

A in Formula (1) is preferably at least one metal element selected from the group consisting of Ga, Al, In, Nb, Co, Zn, Ni, Mn, Ti, and Sn. Since A in the compound represented by Formula (1) is at least one metal element selected from the group consisting of Ga, Al, In, Nb, Co, Zn, Ni, Mn, Ti, and Sn, magnetic properties can be preferably controlled.

In a case where the compound represented by Formula (1) includes Ga, an atomic composition percentage of Ga atoms is preferably 1 atom % to 50 atom % with respect to Fe atoms, and more preferably 5 atom % to 50 atom % with respect to Fe atoms. Since the Ga atoms are included at the atomic composition percentage described above, saturation magnetization or coercivity can be adjusted.

The shape of particles of the ferromagnetic powder can be confirmed by performing observation using a transmission electron microscope (TEM). In addition, the crystal structure thereof can be confirmed by analyzing an X-ray diffraction (XRD) pattern.

Examples of the compound represented by Formula (1) include a compound represented by Formula (2), a compound represented by Formula (3), a compound represented by Formula (4), a compound represented by Formula (5), and a compound represented by Formula (6)

ε-Z_{z}Fe_{2-z}O₃ (2)

In Formula (2), Z represents at least one kind of trivalent metal element selected from the group consisting of Ga, Al, In, and Nb. z satisfies a relationship of 0<z<2. z preferably satisfies a relationship of 0<z<1.8 and more preferably satisfies a relationship of 0.1<z<1.2, from viewpoints of magnetic properties and stable forming of an ε phase.

Specific examples of the compound represented by Formula (2) include ε-Ga_{0.25}Fe_{1.75}O₃ and ε-Ga_{0.5}Fe_{1.50}O₃.

ε-XₓY_{y}Fe_{2-x-y}O₃ (3)

In Formula (3), X represents at least one kind of divalent metal element selected from the group consisting of Co, Ni, Mn, and Zn, and Y represents at least one kind of tetravalent metal element selected from Ti and Sn. x satisfies a relationship of 0<x<1 and y satisfies a relationship of 0<y<1. x preferably satisfies a relationship of 0<x<0.5, from viewpoints of magnetic properties and stable forming of an ε phase. y preferably satisfies a relationship of 0<y<0.5, from viewpoints of magnetic properties and stable forming of an ε phase.

Specific examples of the compound represented by Formula (3) include ε-Co_{0⋅05}Ti_{0⋅05}Fe_{1⋅9}O₃ and ε-Co_{0⋅07}Ti_{0⋅07}Fe_{1⋅86}O₃.

ε-XₓZ_{z}Fe_{2-x-z}O₃ (4)

In Formula (4), X represents at least one kind of divalent metal element selected from the group consisting of Co, Ni, Mn, and Zn, and Z represents at least one kind of trivalent metal element selected from the group consisting of Ga, Al, In, and Nb. x satisfies a relationship of 0<x<1 and z satisfies a relationship of 0<z<1. x preferably satisfies a relationship of 0<x<0.5, from viewpoints of magnetic properties and stable forming of an c phase. z preferably satisfies a relationship of 0<z<1.0, from viewpoints of magnetic properties and stable forming of an ε phase.

Specific examples of the compound represented by Formula (4) include ε-Ga_{0.25}Co_{0.05}Fe_{1.7}O₃ and ε-Ga_{0.3}C_{0.05}Fe_{1.65}O₃.

ε-Y_{y}Z_{z}Fe_{2-y-z}O₃ (5)

In Formula (5), Y represents at least one kind of tetravalent metal element selected from Ti and Sn, and Z represents at least one kind of trivalent metal element selected from the group consisting of Ga, Al, In, and Nb. y satisfies a relationship of 0<y<1 and z satisfies a relationship of 0<z<1.

y preferably satisfies a relationship of 0<y<0.5, from viewpoints of magnetic properties and stable forming of an ε phase. z preferably satisfies a relationship of 0<z<1.2, from viewpoints of magnetic properties and stable forming of an ε phase.

Specific examples of the compound represented by Formula (5) include ε-Ga_{0.3}Ti_{0.05}Fe_{1.65}O₃ and ε-Ga_{0.25}Ti_{0.05}Fe_{1.7}O₃.

ε-XₓY_{y}Z_{z}Fe_{2-x-y-z}O₃ (6)

In Formula (6), X represents at least one kind of divalent metal element selected from the group consisting of Co, Ni, Mn, and Zn, Y represents at least one kind of tetravalent metal element selected from Ti and Sn, and Z represents at least one kind of trivalent metal element selected from the group consisting of Ga, Al, In, and Nb. x satisfies a relationship of 0<x<1, y satisfies a relationship of 0<y<1, z satisfies a relationship of 0<z<1, and x+y+z<2. x preferably satisfies a relationship of 0<x<1.5 and more preferably satisfies a relationship of 0<x<1.0, y preferably satisfies a relationship of 0<y<0.5 and more preferably satisfies a relationship of 0<y<0.3, and z preferably satisfies a relationship of 0<z<0.5 and more preferably satisfies a relationship of 0<z<0.3, respectively, from viewpoints of magnetic properties and stable forming of an ε phase.

Specific examples of the compound represented by Formula (6) include ε-Ga_{0.24}C_{0.05}Ti_{0.05}Fe_{1.66}O₃, ε-Ga_{0.3}Co_{0.05}Ti_{0.05}Fe_{1.6}O₃, ε-Ga_{0.2}Co_{0.05}Ti_{0.05}Fe_{1.7}O₃, and ε-Ga_{0.5}Co_{0.01}Ti_{0.01}Fe_{1.48}O₃.

Hereinafter, the epsilon-type iron oxide-based compounds represented by ε-Fe₂O₃ and Formulae (1) to (6) may be collectively referred to as a “specific epsilon-type iron oxide-based compound”.

An epsilon-type crystal structure of the specific epsilon-type iron oxide-based compound can be confirmed by analyzing an X-ray diffraction (XRD) pattern.

Other Compounds Which Can Be Included in Ferromagnetic Powder

The ferromagnetic powder may include other compounds, if necessary.

As the other compounds, at least one kind of iron oxide selected from α-Fe₂O₃, β-Fe₂O₃, and γ-Fe₂O₃ is used, for example.

In addition, as the other compounds, Fe₃O₄, FeO, and the like may be included. The content of the other compounds is preferably equal to or smaller than 20 parts by mass with respect to 100 parts by mass of the content of the specific epsilon-type iron oxide-based compound.

An average primary particle diameter of the ferromagnetic powder is preferably 2 nm to 60 nm, more preferably 3 nm to 30 nm, and most preferably 5 nm to 25 nm.

The average primary particle diameter of the ferromagnetic powder can be measured by the following procedure.

The primary particle diameter of the ferromagnetic powder can be measured by using a transmission electron microscope (TEM). As the TEM, a transmission electron microscope H-9000 manufactured by Hitachi, Ltd. can be used, for example.

The primary particle diameter of the ferromagnetic powder can be calculated as a value obtained by imaging the ferromagnetic powder at a magnification ratio of 50,000 to 80,000 with the TEM, printing the image on photographic printing paper so that the total magnification becomes 500,000 to obtain an image of particles of the ferromagnetic powder, selecting any particles from the obtained image, tracing an outline of the particle with a digitizer, and calculating a diameter (equivalent circle area diameter) of a circle having the same area as the traced region. In the image analysis performed in the calculation of the equivalent circle area diameter, well-known image analysis software, for example, image analysis software KS-400 manufactured by Carl Zeiss can be used. The primary particle diameter is a particle diameter of an independent particle which is not aggregated.

In addition, an arithmetical mean value of the primary particle diameters of the plurality of particles (for example, 500 particles) is set as an “average primary particle diameter”.

Sample particles of the ferromagnetic powder for measuring the average primary particle diameter may be raw material powder or sample powder collected from the magnetic layer.

The collecting of the sample powder from the magnetic layer can be performed by the following method, for example.

1. The surface treatment is performed with respect to the surface of the magnetic layer with a plasma reactor manufactured by Yamato Scientific Co., Ltd. for 1 minute to 2 minutes, and an organic component (binding agent component and the like) on the surface of the magnetic layer is incinerated and removed.

2. A filter paper dipped in an organic solvent such as cyclohexanone or acetone is bonded to an edge portion of a metal rod, the surface of the magnetic layer subjected to the treatment of 1. is rubbed thereon, the component of the magnetic layer is peeled off and transferred to the filter paper from the magnetic recording medium.

3. The component peeled in 2. is shaken off to fall into an organic solvent such as cyclohexanone or acetone (the filter paper is put into the solvent and the component is shaken off by an ultrasonic disperser), the organic solvent is dried, and the peeled component is extracted.

4. The component scraped off in 3. is put into a sufficiently washed glass test tube, approximately 20 ml of n-butylamine with respect to the amount of the component of the magnetic layer is added thereto, and the glass test tube is sealed (the amount of n-butylamine capable of decomposing the remaining binding agent without being incinerated is added).

5. The glass test tube is heated at 170° C. for 20 hours or longer, and the binding agent and the curing agent component are decomposed.

6. The precipitate after the decomposition in 5. is sufficiently washed with pure water and dried, and powder is extracted.

With the steps described above, the sample powder can be collected from the magnetic layer and used for the measurement of the average primary particle diameter.

Composition of Epsilon-Type Iron Oxide-Based Compound

The composition of the epsilon-type iron oxide-based compound is confirmed by a high-frequency inductively coupled plasma (ICP) emission spectral analysis method. Specifically, a vessel containing 12 mg of a ferromagnetic powder sample including the epsilon-type iron oxide-based compound and 10 ml of a hydrochloric acid aqueous solution having a concentration of 4 mol/L is held on a hot plate at a set temperature of 80° C. for 3 hours, and a solution is obtained. Then, the obtained solution is filtered by using a membrane filter having a hole diameter of 0.1 μm. The element analysis of the filtrate obtained as described above is performed by using a high-frequency inductively coupled plasma (ICP) emission spectral analysis device. A content of each metal atom with respect to 100 atom % of iron atoms is obtained based on the result obtained from the element analysis.

Binding Agent

The binding agent is selected from film forming resins which are useful for forming the magnetic layer including the ferromagnetic powder described above.

The resin used for the binding agent is not particularly limited, as long as it can form a resin layer satisfying various physical properties such as desired hardness or durability. The resin can be suitably selected from well-known film forming resins according to the purpose and used as the binding agent.

The resin used for the binding agent may be a homopolymer or a copolymer. The resin used for the binding agent may be a well-known electron beam-curable resin.

Examples of the resin used for the binding agent include resins selected from polyurethane, polyester, polyamide, a vinyl chloride resin, polystyrene, polyacrylonitrile, an acryl resin obtained by (co)polymerization of methacrylate, a cellulose resin such as nitrocellulose, an epoxy resin, a phenoxy resin, and a polyvinylalkylal resin such as polyvinyl acetal or polyvinyl butyral. As the resin used for the binding agent, the resins described above can be used alone or the plurality of resins can be used. Among these, polyurethane, the acryl resin, the cellulose resin, and the vinyl chloride resin are preferable.

In order to further improve dispersibility of the ferromagnetic powder included in the magnetic layer, the resin which is the binder preferably includes a functional group which can be adsorbed to the surface of the powder, for example, a polar group in a molecule. Examples of the preferable functional group which can be included in the resin which is the binding agent include —SO₃M, —SO₄M, —PO(OM)₂, —OPO(OM)₂, —COOM, =NSO₃M, =NRSO₃M, —NR¹R², and —N⁺R¹R²R³X⁻. Here, M represents a hydrogen atom or an alkali metal atom such as Na or K. R represents an alkylene group, R1, R2, and R3 each independently represent a hydrogen atom, an alkyl group, or a hydroxyalkyl group. X represents a halogen atom such as Cl or Br.

In a case where the resin which is the binding agent includes the functional group, the content of the functional group in the resin is preferably 0.01 meq/g to 2.0 meq/g, and more preferably 0.3 meq/g to 1.2 meq/g. It is preferable that the content of functional group in the resin is set to be in the range described above, because dispersibility of the ferromagnetic powder and the like in the magnetic layer is further improved and magnetic flux density is further improved.

Among these, the resin used for the binding agent is more preferably polyurethane including a —SO₃Na group. In a case where polyurethane includes the —SO₃Na group, the content of —SO₃Na group is preferably 0.01 meq/g to 1.0 meq/g with respect to that of polyurethane.

As the binding agent, a commercially available resin can be suitably used.

An average molecular weight of the resin used as the binding agent can be, for example, 10,000 to 200,000 as a weight-average molecular weight.

The weight-average molecular weight in this disclosure is a value obtained by performing polystyrene conversion of a value measured by gel permeation chromatography (GPC). As the measurement conditions, the following conditions can be used.

GPC device: HLC-8120 (manufactured by Tosoh Corporation)

Column: TSK gel Multipore HXL-M (manufactured by Tosoh Corporation, 7.8 mmID (inner diameter)×30.0 cm)

Eluent: Tetrahydrofuran (THF)

Sample concentration: 0.5% by mass

Sample injection amount: 10 μl

Flow rate: 0.6 ml/min

Measurement temperature: 40° C.

Detector: RI detector

The content of the binding agent (including the binding agent having a crosslinked structure) in the magnetic layer can be 1 part by mass to 50 parts by mass, is preferably 3 parts by mass to 40 parts by mass, and more preferably 5 parts by mass to 30 parts by mass with respect to 100 parts by mass of the ferromagnetic powder. By setting the content of the binding agent in the magnetic layer to be in the range described above, the amounts of the ferromagnetic powder and the binding agent in the magnetic layer of the magnetic recording medium of this disclosure are in suitable ranges, a hard film is formed on the magnetic layer, thereby improving film hardness of the magnetic layer of the magnetic recording medium.

Other Additives

The magnetic layer can include various additives, if necessary, in addition to the ferromagnetic powder and the binding agent described above, within a range not negatively affecting the effects of the magnetic layer.

Examples of the additives include an abrasive, a lubricant, a dispersing agent, a dispersing assistant, an antibacterial agent, an antistatic agent, an antioxidant, and carbon black. In addition, as the additives, colloid particles as an inorganic filler can be used, if necessary.

As the additive, a commercially available product can be suitably used according to desired properties.

Abrasive

The magnetic layer can include an abrasive. In a case where the magnetic layer includes an abrasive, attached materials which are attached to a head during the usage of the magnetic recording medium can be removed.

As the abrasive, mainly well-known materials having Mohs hardness equal to or greater than 6 such as α-alumina having an a transformation rate equal to or greater than 90%, β-alumina, silicon carbide, chromium oxide, cerium oxide, α-iron oxide, corundum, artificial diamond, silicon nitride, silicon carbide, titanium carbide, titanium oxide, silicon dioxide, and boron nitride are preferably used alone or in combination thereof. In addition, a complex of these abrasives (abrasive subjected to surface treatment with another abrasive) may be used.

A compound or an element other than the metal compound particles which are main components may be included in the abrasive, but there is no change in effect, as long as the content of the main component is equal to or greater than 90% by mass.

In addition, as the abrasive, a material obtained by performing surface treatment of the particles may be used.

As the abrasive, a commercially available product can be suitably used.

Specific examples of the commercially available product of the abrasive include AKP-12, AKP-15, AKP-20, AKP-30, AKP-50, HIT20, HIT30, HIT55, HIT60A, HIT70, HIT80, and HIT100 manufactured by Sumitomo Chemical Co., Ltd.; ERC-DBM, HP-DBM, and HPS-DBM manufactured by Reynolds Co., Ltd.; WA10000 manufactured by Fujimi Incorporated; UB20 manufactured by Uyemura & Co., Ltd.; G-5, Kromex U2, and Kromex U1 manufactured by Nippon Chemical Industrial Co., Ltd.; TF100 and TF140 manufactured by Toda Kogyo Corp.; Beta Random Ultrafine manufactured by IBIDEN CO., LTD.; and B-3 manufactured by Showakogyo Co., Ltd.

A particle size of these abrasive is preferably 0.01 μm to 2 μm, more preferably 0.05 μm to 1.0 μm, and even more preferably 0.05 μm to 0.5 μm.

Particularly, in order to increase electromagnetic conversion characteristics of the magnetic recording medium, it is preferable that particle size distribution of the abrasive is narrow. In addition, in order to improve running durability, the same effect can also be exhibited by combining abrasives having different particle sizes, if necessary, or widening the particle size distribution even with a single abrasive. Regarding the abrasive, a tap density is preferably 0.3 g/ml to 2 g/ml, a water content thereof is preferably 0.1% to 5%, pH thereof is preferably 2 to 11, and a BET specific surface area (SBET) is preferably 1 m2/g to 30 m2/g.

The shape of the abrasive may be any of a needle shape, a sphere shape, or a cube shape, and a particle having a shape including a corner in a part is preferable due to high abrasive properties.

In a case where the magnetic layer includes the abrasive, the content thereof is preferably 1 part by mass to 10 parts by mass with respect to 100 parts by mass of the ferromagnetic powder.

Lubricant

The magnetic layer can include a lubricant.

In a case where the magnetic layer includes the lubricant, running durability of the magnetic recording medium can be improved, for example.

As the lubricant, a well-known hydrocarbon-based lubricant and a fluorine-based lubricant can be used.

As the lubricant, a commercially available product may be suitably used.

As the lubricant, a well-known hydrocarbon-based lubricant, a fluorine-based lubricant, or an extreme pressure additive can be used.

Examples of the hydrocarbon-based lubricant include carboxylic acids such as stearic acid or oleic acid; esters such as butyl stearate; sulfonic acids such as octadecylsulfonic acid; phosphoric acid esters such as monoctadecyl phosphate; alcohols such as stearyl alcohol or oleyl alcohol; carboxylic acid amide such as stearic acid amide; and amines such as stearyl amine.

As the fluorine-based lubricant, a lubricant obtained by substituting a part of or the entire alkyl group of the hydrocarbon-based lubricant with a fluoroalkyl group or a perfluoropolyether group.

Examples of the perfluoropolyether group include a perfluoromethylene oxide polymer, a perfluoroethylene oxide polymer, a perfluoro-n-propylene oxide polymer (CF₂CF₂CF₂O)ₙ, a perfluoroisopropylene oxide polymer (CF(CF₃)CF₂O)ₙ, or a copolymer thereof.

In addition, a compound including a polar functional group such as a hydroxyl group, an ester group, or a carboxyl group at a terminal or in a molecule of the alkyl group of the hydrocarbon-based lubricant is suitable due to a high effect of decreasing a frictional force.

A molecular weight thereof is 500 to 5,000 and preferably 1,000 to 3,000. By setting the molecular weight thereof to be 500 to 5,000, it is possible to prevent volatilization and prevent a deterioration in lubricity.

Specifically, this perfluoropolyether is, for example, commercially available as a product name such as FOMBLIN manufactured by Ausimont or KRYTOX manufactured by DuPont.

Examples of the extreme pressure additive include phosphate esters such as trilauryl phosphate; Phosphite esters such as trilauryl phosphate; thiophosphite esters or thiophosphate esters such as trilauryl trithiophosphite; and a sulfur-based extreme pressure agent such as dibenzyl disulfide.

In a case where the magnetic layer includes the lubricant, the lubricant may be used alone or in combination of two or more kinds thereof.

In a case where the magnetic layer includes the lubricant, the content thereof is preferably 0.1 parts by mass to 5 parts by mass with respect to 100 parts by mass of ferromagnetic powder.

Non-Magnetic Filler

The magnetic layer can include a non-magnetic filler. The non-magnetic filler is preferably colloid particles, from viewpoints of dispersibility and surface roughness.

The colloid particles are preferably inorganic colloid particles or more preferably inorganic oxide colloid particles, from a viewpoint of availability. Examples of the inorganic oxide colloid particles include complex inorganic oxide colloid particles such as SiO₂/Al₂O₃, SiO₂/B₂O₃, TiO₂/CeO₂, SnO₂/Sb₂O₃, SiO₂/Al₂O₃/TiO₂, or TiO₂/CeO₂/SiO₂. Inorganic oxide colloid particles such as SiO₂, Al₂O₃, TiO₂, ZrO₂, or Fe₂O₃ can be preferably used, and silica colloid particles (colloidal silica) are particularly preferable, from a viewpoint of availability of monodisperse colloid particles.

In a case where the magnetic layer includes the non-magnetic filler, the non-magnetic filler may be used alone or in combination of two or more kinds thereof.

As the non-magnetic filler, a commercially available product can be suitably used.

In a case where the magnetic layer includes the non-magnetic filler, the content thereof is preferably 1 part by mass to 10 parts by mass with respect to 100 parts by mass of ferromagnetic powder.

A thickness of the magnetic layer can be optimized according to a saturation magnetization amount of a magnetic head used, a head gap length, a recording signal band, and the like. The thickness of the magnetic layer is preferably 10 nm to 350 nm, more preferably 15 nm to 200 nm, even more preferably 20 nm to 150 nm, from viewpoints of improvement of electromagnetic conversion characteristics of the magnetic recording medium and film hardness of the magnetic layer.

The magnetic layer may be at least one layer, or the magnetic layer can be separated to two or more layers having magnetic properties, and a configuration regarding a well-known multilayered magnetic layer can be applied. In a case of the multilayered magnetic layer, the thickness of the magnetic layer is a total thickness of the plurality of magnetic layers.

In the magnetic layer, a mass ratio of mass of a nonvolatile component with respect to mass of the ferromagnetic powder (nonvolatile component/ferromagnetic powder) is preferably 0.15 to 1.8, more preferably 0.3 to 1.8, and even more preferably 0.6 to 1.0. By setting the nonvolatile component/ferromagnetic powder to be 0.15 to 1.8, excellent film hardness of the magnetic layer is obtained. In addition, by setting the nonvolatile component/ferromagnetic powder to be 0.3 to 1.8, further excellent film hardness of the magnetic layer is obtained, and by setting the nonvolatile component/ferromagnetic powder to be 0.6 to 1.0, particularly excellent film hardness of the magnetic layer is obtained.

Here, the “nonvolatile component” of the magnetic layer is a component obtained by removing ferromagnetic powder from a component is not volatilized after drying a magnetic layer forming composition. Here, the “magnetic layer forming composition” includes ferromagnetic powder, a binding agent, and a solvent, and further includes additives, if necessary. In addition, the “nonvolatile component” of the magnetic layer is the binding agent and the additive included in the magnetic layer.

Hereinafter, the non-magnetic layer and the back coating layer which are predetermined layers of the magnetic recording medium will be described.

Non-Magnetic Layer

The non-magnetic layer is a layer contributing to thinning of the magnetic layer. The non-magnetic layer is preferably a layer including non-magnetic powder as a filler and a binding agent which is a film forming component, and may further include additives, if necessary.

The non-magnetic layer can be provided between the non-magnetic support and the magnetic layer. The non-magnetic layer includes a layer not having magnetism, and a substantially non-magnetic layer including a small amount of ferromagnetic powder as impurities or intentionally.

Here, the “non-magnetic” state is the same as described regarding the “non-magnetic support”.

Non-Magnetic Powder

The non-magnetic powder is powder not having magnetism, which functions as a filler. The non-magnetic powder used in the non-magnetic layer may be inorganic powder or organic powder. In addition, carbon black or the like can also be used. Examples of the inorganic powder include powder of metal, metal oxide, metal carbonate, metal sulfate, metal nitride, metal carbide, and metal sulfide. The non-magnetic powder can be used alone or in combination of two or more kinds thereof. The non-magnetic powder can be purchased as a commercially available product or can be manufactured by a well-known method.

Specifically, titanium oxide such as titanium dioxide, cerium oxide, tin oxide, tungsten oxide, ZnO, ZrO₂, SiO₂, Cr₂O₃, α-alumina having an a transformation rate of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide can be used alone or in combination of two or more kinds thereof. α-iron oxide and titanium oxide are preferable.

The shape of the non-magnetic powder may be any of a needle shape, a sphere shape, a polyhedron shape, and a plate shape. A crystallite size of the non-magnetic powder is preferably 4 nm to 500 nm and more preferably 40 nm to 100 nm. It is preferable that the crystallite size is 4 nm to 500 nm, because suitable surface roughness is obtained without any difficulties regarding dispersion. An average particle diameter of these non-magnetic powders is preferably 5 nm to 500 nm, and the same effect can also be exhibited by combining non-magnetic powders having different average particle diameters, if necessary, or widening the particle size distribution even with a single non-magnetic powder. The average particle diameter of the non-magnetic powder is particularly preferably 10 nm to 200 nm. It is preferable that the average particle diameter of the non-magnetic powder is 5 nm to 500 nm, because dispersion is performed in an excellent manner and suitable surface roughness is obtained.

A content (filling percentage) of the non-magnetic powder in the non-magnetic layer is preferably 50% by mass to 90% by mass and more preferably 60% by mass to 90% by mass.

The “binding agent” and the “additive” of the non-magnetic layer are the same as the “binding agent” and the “additive” described in the section of the “magnetic layer” and the preferable aspects are also the same as the preferable aspects thereof.

A thickness of the non-magnetic layer is preferably 0.05 μm to 3.0 μm, more preferably 0.05 μm to 2.0 μm, and even more preferably 0.05 μm to 1.5 μm.

Back Coating Layer

A back coating layer is a layer contributing to temporal stability, running stability, and the like. The back coating layer is preferably a layer including non-magnetic powder as a filler, and a binding agent which is a film forming component, and may further include additives, according to the purpose.

The back coating layer can be provided on a surface of the non-magnetic support on a side opposite to the magnetic layer side.

The “non-magnetic powder” of the back coating layer is the same as the “non-magnetic powder” described in the section of the “non-magnetic layer” and the preferable aspect is also the same as the preferable aspect thereof. In addition, the “binding agent” and the “additive” of the back coating layer are the same as the “binding agent” and the “additive” described in the section of the “magnetic layer” and the preferable aspects are also the same as the preferable aspects thereof.

A thickness of the back coating layer is preferably equal to or smaller than 0.9 μm and more preferably 0.1 μm to 0.7 μm.

Manufacturing Method of Magnetic Recording Medium

A manufacturing method of the magnetic recording medium of this disclosure is not particularly limited, and a well-known manufacturing method can be used.

As the manufacturing method of the magnetic recording medium, a manufacturing method including a step of preparing a magnetic layer forming composition (step (A)), a step of applying the magnetic layer forming composition onto a non-magnetic support to form a magnetic layer forming composition layer (step (B)), a step of performing alignment in magnetic field of the formed magnetic layer forming composition layer (step (c)), and a step of drying the magnetic layer forming composition layer subjected to the alignment in magnetic field to form a magnetic layer (step (D)) is used, for example.

The manufacturing method of the magnetic recording medium can further includes a step of performing a calender process of the non-magnetic support including the magnetic layer, and a step of forming any layer such as a non-magnetic layer and a back coating layer.

Each step may be divided into two or more stages.

Step (A)

The manufacturing method of the magnetic recording medium preferably includes the step of preparing a magnetic layer forming composition (step (A)).

The step (A) includes adding and dispersing ferromagnetic powder, a binding agent, and if necessary, additives in a solvent.

All of the raw materials such as the ferromagnetic powder, the binding agent, the non-magnetic powder, and additives of this disclosure may be added in any stage of the step (A).

The raw materials may be added at the same time or may be added in two or more parts. For example, after adding the binding agent in a dispersion step, the binding agent can be further added for viscosity adjustment after the dispersion.

In the dispersion of the raw materials of the magnetic layer forming composition, a well-known dispersion apparatus such as a batch type vertical sand mill or a transverse beads mill can be used, for example. As the dispersion beads, glass beads, zirconia beads, titania beads, and steel beads can be used, for example. A particle diameter (bead diameter) and a filling percentage of the dispersion beads can be optimized and used.

In addition, the dispersion of the raw materials of the magnetic layer forming composition can also be performed by using a well-known ultrasonic device, for example.

Further, at least some raw materials of the magnetic layer forming composition can also be kneaded by using an open kneader, for example, before the dispersion.

Regarding the raw materials of the magnetic layer forming composition, solutions for the raw materials may be respectively prepared and mixed with each other. For example, a magnetic liquid including ferromagnetic powder and an abrasive solution including the abrasive can be respectively prepared, and mixed with each other for dispersion.

Magnetic Layer Forming Composition

The magnetic layer forming composition includes ferromagnetic powder, a binding agent, and a solvent, and may include a curing agent and additives, if necessary.

The “ferromagnetic powder”, the “binding agent”, and the “additive” for preparing the magnetic layer forming composition are the same as the “ferromagnetic powder”, the “binding agent”, and the “additive” described in the section of the “magnetic layer” and the preferable aspects are also the same as the preferable aspects thereof.

A content of the ferromagnetic powder in the magnetic layer forming composition is preferably 5% by mass to 50% by mass and more preferably 10% by mass to 30% by mass, with respect to a total mass of the magnetic layer forming composition.

A content of the binding agent in the magnetic layer forming composition is preferably 1 part by mass to 30 parts by mass and more preferably 2 parts by mass to 20 parts by mass with respect to 100 parts by mass of the ferromagnetic powder.

Solvent

The solvent is a medium for dispersing the ferromagnetic powder, the binding agent, and if necessary, the additives.

One kind of the solvent may be used or a mixed solvent of two or more kinds may be used. As the solvent, an organic solvent is preferable.

As the organic solvent, a ketone-based compound such as acetone, methyl ethyl ketone, methyl isobutyl ketone, diisobutyl ketone, cyclohexanone, isophorone, or tetrahydrofuran, an alcohol-based compound such as methanol, ethanol, propanol, butanol, isobutyl alcohol, isopropyl alcohol, or methylcyclohexanol, an ester-based compound such as methyl acetate, butyl acetate, isobutyl acetate, isopropyl acetate, ethyl lactate, or glycol acetate, a glycol ether-based compound such as glycol dimethyl ether, glycol monoethyl ether, or dioxane, an aromatic hydrocarbon-based compound such as benzene, toluene, xylene, cresol, or chlorobenzene, a chlorinated hydrocarbon-based compound such as methylene chloride, ethylene chloride, carbon tetrachloride, chloroform, ethylene chlorohydrin, or dichlorobenzene, N, N-dimethylformamide, hexane, and the like can be used, for example. Preferable examples of the organic solvent include methyl ethyl ketone, cyclohexanone, and a mixed solvent including these at any ratio.

In order to improve dispersibility, a solvent having strong polarity to some extent is preferable, and it is preferable that a content of a solvent having dielectric constant equal to or greater than 15 is equal to or greater than 50% by mass with respect to a total content of the solvent. In addition, a dissolution parameter is preferably 8 to 11.

Curing Agent

The magnetic layer forming composition can include a curing agent.

In a case where the magnetic layer forming composition includes a curing agent, the binding agent and the curing agent included in the magnetic layer react with each other, in a case of forming a magnetic layer, and accordingly, a binding agent having a crosslinked structure is formed, thereby further improving film hardness of the magnetic layer.

As the curing agent, an isocyanate-based compound is preferable. Examples of the isocyanate-based compound include isocyanate-based compounds such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate. A product of these isocyanate-based compounds and polyalcohol, and di- or higher valent functional polyisocyanate generated due to condensation of the isocyanate-based compound can be used.

The presence of the binding agent having a crosslinked structure is confirmed by causing impregnation of the solvent used in the magnetic layer forming composition, wiping the solvent with a wipe, visually observing the wipe, and confirming that there is no attachments. In addition, the confirmation can also be performed by heating the wipe used for wiping at 40° C. to 80° C. in the solvent, removing the wipe, performing FT-IR, gas chromatography, and gel permeation chromatography measurement regarding the remaining solution, and confirming that a component derived from the added binding agent is not detected.

As the curing agent, a commercially available product can be suitably used. Examples of the product name of a commercially available isocyanate-based compound include CORONATE (registered trademark) L, CORONATE (registered trademark) HL, CORONATE (registered trademark) 2030, CORONATE (registered trademark) 2031, CORONATE (registered trademark) 3041, MILLIONATE (registered trademark) MR, and MILLIONATE (registered trademark) MTL manufactured by Nippon Polyurethane Industry Co., Ltd., TAKENATE (registered trademark) D-102, TAKENATE (registered trademark) D-110N, TAKENATE (registered trademark) D-200, and TAKENATE (registered trademark) D-202 manufactured by Takeda Pharmaceutical Company Limited, DESMODUR L, DESMODUR IL, DESMODUR N, and DESMODUR HL manufactured by Sumitomo Bayer Co., Ltd.

In a case where the magnetic layer forming composition includes the curing agent, the curing agent may be used alone or in combination of two or more kinds thereof.

In a case where the magnetic layer forming composition includes the curing agent, a content of the curing agent may be 0.1 parts by mass to 20 parts by mass with respect to 100.0 parts by mass of the ferromagnetic powder, and is preferably 0.5 parts by mass to 15 parts by mass, and more preferably 1 part by mass to 10 parts by mass, from a viewpoint of improving hardness of the magnetic layer.

In a case where the magnetic layer forming composition includes the curing agent, the content of the curing agent may be 1 part by mass to 50 parts by mass with respect to 100.0 parts by mass of the binding agent, and is preferably 4 parts by mass to 40 parts by mass and more preferably 6 parts by mass to 30 parts by mass, from a viewpoint of improving hardness of the magnetic layer.

The curing agent can be included in a forming composition for another layer, in order to improve film hardness of the other layer, in a case of forming the other layer.

Step (B)

The manufacturing method of the magnetic recording medium of this disclosure preferably includes a step of applying the magnetic layer forming composition onto the non-magnetic support to form a magnetic layer forming composition layer (step (B)), after the composition preparation step.

The step (B) can be performed, for example, by applying the magnetic layer forming composition onto the running non-magnetic support so as to obtain a predetermined film thickness. The preferable film thickness of the magnetic layer is as described in the section of the “magnetic layer”.

As a coating method of applying the magnetic layer forming composition onto a surface of the non-magnetic support, a well-known method such as air doctor coating, blade coating, rod coating, extrusion coating, air knife coating, squeeze coating, impregnation coating, reverse roll coating, transfer roll coating, gravure coating, kiss coating, cast coating, spray coating, spin coating can be used. Regarding the coating method, “Latest coating technologies” published by Sogo Gijutsu Center (31 May 1983) can be referred to, for example.

Step (C)

The manufacturing method of the magnetic recording medium of this disclosure preferably includes a step of performing alignment in magnetic field of the formed magnetic layer forming composition layer (step (C)), after the composition layer formation step.

In a case where the non-magnetic support has a film shape such as a magnetic tape, alignment in magnetic field of the formed magnetic layer forming composition layer can be performed with respect to the ferromagnetic powder included in the magnetic layer forming composition by using cobalt magnets or solenoid. In a case where the non-magnetic support is a support for a hard disk, isotropic orientation is sufficiently obtained without performing an alignment process without using an alignment device. A well-known random alignment device is preferably used by obliquely alternately disposing cobalt magnets or applying an alternating magnetic field by solenoid. In addition, isotropic magnetic properties can also be applied in a circumferential direction by performing homeotropic alignment by using a well-known method such as a method using a polar opposing magnet. Particularly, in a case of performing high-density recording, homeotropic alignment is preferable. In addition, circumferential alignment can also be performed by using a spin coating.

The alignment in magnetic field is preferably performed before drying the formed magnetic layer forming composition layer.

The alignment in magnetic field can be performed by a homeotropic alignment process of applying a magnetic field having magnetic field strength of 0.1 T to 1.0 T in a vertical direction to the surface of the formed magnetic layer forming composition layer.

Step (D)

The manufacturing method of the magnetic recording medium of this disclosure preferably includes a step of drying the magnetic layer forming composition layer subjected to the alignment in magnetic field to form a magnetic layer (step (D)), after the step (C) of performing the alignment in magnetic field.

In the drying of the magnetic layer forming composition layer, it is possible to control the drying of the magnetic layer forming composition layer by controlling a temperature of dry air, an air flow, or an application speed. For example, the application speed is preferably 20 m/min to 1,000 m/min and a temperature of the dry air is preferably equal to or higher than 60° C. In addition, preliminary drying of the composition can be suitably performed before applying a magnetic field.

Calender Process Step

In the manufacturing method of the magnetic recording medium of this disclosure, after the magnetic layer is formed on the non-magnetic support through the step (A), the step (B), the step (C), and the step (D), a step of performing a calender process with respect to the non-magnetic support including the magnetic layer is preferably performed.

The non-magnetic support including the magnetic layer is temporarily wound with a winding roll, unwound from the winding roll, and supplied for the calender process. By performing the calender process, surface smoothness is improved, and a filling percentage of the ferromagnetic powder in the magnetic layer is improved due to disappearance of holes generated due to removal of the solvent at the time of drying. Accordingly, it is possible to obtain a magnetic recording medium having high electromagnetic conversion characteristics. The calender process is preferably performed while changing calender process conditions according to smoothness of the surface of the magnetic layer.

In the calender process, a super calender roll or the like can be used, for example.

As a calender roll, a heat resistant plastic roll such as epoxy, polyimide, polyamide, or polyamideimide can be used. In addition, the process can also be performed by a metal roll.

As the calender process conditions, a temperature of the calender roll can be, for example, 60° C. to 120° C. and can be preferably set as 80° C. to 100° C., and pressure can be, for example, 100 kg/cm to 500 kg/cm (98 kN/m to 490 kN/m) and can be preferably set as 200 to 450 kg/cm (196 to 441 kN/m).

Step of Forming any Layer Such as Non-Magnetic Layer and Back Coating Layer

The manufacturing method of the magnetic recording medium of this disclosure can include a step of forming any layer such as the non-magnetic layer and the back coating layer.

The non-magnetic layer and the back coating layer can be formed by performing the same steps as the step (B), the step (C), and the step (D) for forming the magnetic layer, after preparing the composition for forming each layer.

As described in the sections of the “non-magnetic layer” and the “back coating layer”, the non-magnetic layer can be provided between the non-magnetic support and the magnetic layer, and the back coating layer can be provided on a surface of the non-magnetic support on a side opposite to the side provided with the magnetic layer.

A forming composition of the non-magnetic layer and a forming composition of the back coating layer can be prepared with components and the contents described in the sections of the “non-magnetic layer” and the “back coating layer”.

### EXAMPLES

Hereinafter, this disclosure will be described more specifically with reference to examples, but the invention is not limited to the following examples, as long as other examples are not departed from the gist thereof. “Parts” and “%” are based on mass, unless otherwise noted.

### Example 1

3.7 g of a 25% by mass ammonia aqueous solution was added to a mixture obtained by dissolving 8.2 g of iron (III) nitrate nonahydrate, 1.2 g of gallium (III) nitrate octahydrate, 187 mg of cobalt (II) nitrate hexahydrate, 151 mg of titanium (IV) sulfate, and 1.1 g of polyvinylpyrrolidone (PVP) in 92 g of pure water, while stirring by using a magnetic stirrer, in an atmosphere under the conditions of 25° C., and this solution was stirred for 2 hours. A solution obtained by dissolving 0.8 g of citric acid to 9.2 g of water was added thereto and stirred for 1 hour. Precipitated powder was collected by centrifugal separation, washed with pure water, and dried at 80° C. Then, 800 g of pure water was added to the obtained powder, and water dispersion was performed with respect to the powder again. This was heated to 50° C., and 39 g of a 25% by mass ammonia aqueous solution B was added dropwise, while stirring. This solution was stirred for 1 hour, and 13.4 mL of tetraethoxysilane (TEOS) was added dropwise, and stirred for 24 hours. 51 g of ammonium sulfate was added thereto, the precipitated powder was collected by centrifugal separation, washed with pure water, and dried at 80° C., thereby obtaining powder which is a precursor of an epsilon-type iron oxide-based compound.

A furnace was filled with the obtained powder of the precursor, and heat treatment was performed under atmosphere at 1,028° C. for 4 hours, thereby obtaining heat-treated powder. This was put into a 4 mol/L sodium hydroxide (NaOH) aqueous solution and stirred at a liquid temperature of 70° C. for 24 hours, thereby removing silicon oxide from the heat-treated powder. This powder was collected by centrifugal separation and washed with pure water, and ferromagnetic powder including an epsilon-type iron oxide-based compound (ε-Ga_{0.24}Co_{0.05}Ti_{0.05}Fe_{1.66}O₃) having a ε-Fe₂O₃ phase was obtained.

The composition of the epsilon-type iron oxide-based compound was confirmed by a high-frequency inductively coupled plasma (ICP) emission spectral analysis method. Specifically, a vessel containing 12 mg of the ferromagnetic powder and 10 ml of a hydrochloric acid aqueous solution having a concentration of 4 mol/L was held on a hot plate at a set temperature of 80° C. for 3 hours, and a solution was obtained. Then, the obtained solution was filtered by using a membrane filter having a hole diameter of 0.1 μm. The element analysis of the filtrate obtained as described above was performed by using a high-frequency inductively coupled plasma (ICP) emission spectral analysis device (product name: ICPS-8100, manufactured by Shimadzu Corporation). A content of each metal atom with respect to 100 atom % of iron atoms was obtained based on the result obtained from the element analysis.

An epsilon-type crystal structure of the epsilon-type iron oxide-based compound was confirmed by X-ray diffraction (XRD). The analysis was performed by using X'Pert PRO (manufactured by PANalytical) as an XRD device.

An average primary particle diameter of the ferromagnetic powder calculated by a method which will be described later was 13.3 nm.

Average Primary Particle Diameter

The powder of the epsilon-type iron oxide-based compound was imaged at a magnification ratio of 80,000 by using a transmission electron microscope H-9000 manufactured by Hitachi, Ltd., the image was printed on photographic printing paper so that the total magnification becomes 500,000, and an image of the epsilon-type iron oxide-based compound was obtained.

Target particle was selected from the obtained image of the particles, an outline of the particle was traced with a digitizer, and a diameter (equivalent circle area diameter) of a circle having the same area as the traced region was calculated, thereby obtaining a “primary particle diameter”. The measurement of the primary particle diameter can be performed by using well-known image analysis software, for example, image analysis software KS-400 manufactured by Carl Zeiss can be used. The primary particle diameter is a particle diameter of an independent particle which is not aggregated.

In addition, an arithmetical mean of the primary particle diameters of the plurality of particles (for example, 500 particles) is set as an “average primary particle diameter”.

Manufacturing of Magnetic Recording Medium (Magnetic Tape)

(1) Magnetic Layer Forming Composition List

Magnetic Liquid

Ferromagnetic powder (powder of the epsilon-type iron oxide-based compound prepared in Example 1): 100.0 parts

SO₃Na group-containing polyurethane resin (binding agent): 14.0 parts
(Weight-average molecular weight: 70,000, SO₃Na group: 0.4 meq/g)

Cyclohexanone: 150.0 parts

Methyl ethyl ketone: 150.0 parts

Abrasive solution

Abrasive solution A

Alumina abrasive (average particle size: 100 nm): 3.0 parts

Sulfonic acid group-containing polyurethane resin: 0.3 parts
(Weight-average molecular weight: 70,000, SO₃Na group: 0.3 meq/g)

Cyclohexanone: 26.7 parts

Abrasive solution B

Diamond abrasive (average particle size: 100 nm): 1.0 parts

Sulfonic acid group-containing polyurethane resin: 0.1 parts
(Weight-average molecular weight: 70,000, SO₃Na group: 0.3 meq/g)

Cyclohexanone: 26.7 parts

Silica Sol

Colloidal silica (average particle size: 100 nm): 0.2 parts

Methyl ethyl ketone: 1.4 parts

Other components

Stearic acid: 2.0 parts

Butyl stearate: 6.0 parts

Polyisocyanate (CORONATE (registered trademark) 3041 manufactured by Nippon Polyurethane Industry Co., Ltd.; curing agent): 2.5 parts

Finishing additive solvent

Cyclohexanone: 200.0 parts

Methyl ethyl ketone: 200.0 parts

(2) Non-Magnetic Layer Forming Composition List

Non-magnetic inorganic powder α-iron oxide: 100.0 parts
Average particle size: 10 nm
Average acicular ratio: 1.9
BET specific surface area: 75 m2/g

Carbon black (average particle size: 20 nm): 25.0 parts

SO₃Na group-containing polyurethane resin (binding agent): 18.0 parts
(Weight-average molecular weight: 70,000, SO₃Na group: 0.2 meq/g)

Stearic acid: 1.0 parts

Cyclohexanone: 300.0 parts

Methyl ethyl ketone: 300.0 parts

(3) Back Coating Layer Forming Composition List

Non-magnetic inorganic powder α-iron oxide: 80.0 parts
Average particle size: 0.15 μm
Average acicular ratio: 7
BET specific surface area: 52 m2/g

Carbon black (average particle size: 20 nm): 20.0 parts

A vinyl chloride copolymer: 13.0 parts

Sulfonic acid group-containing polyurethane resin: 6.0 parts

Phenylphosphonic acid: 3.0 parts

Cyclohexanone: 155.0 parts

Methyl ethyl ketone: 155.0 parts

Stearic acid: 3.0 parts

Butyl stearate: 3.0 parts

Polyisocyanate: 5.0 parts

Cyclohexanone: 200.0 parts

(4) Manufacturing of Magnetic Tape

The components shown in the list of the magnetic liquid were dispersed by using a batch type vertical sand mill for 24 hours and magnetic liquid was prepared. As dispersion beads, zirconia beads having a particle diameter of 0.5 mmϕ were used. The components shown in the list of the abrasive solution were dispersed by a batch type ultrasonic device (20 kHz, 300 W) for 24 hours, and an abrasive solution was prepared. These dispersion liquids were mixed with other components (silica sol, other components, and the finishing additive solvent), and then, a process was performed by a batch type ultrasonic device (20 kHz, 300 W) for 30 minutes. After that, filtering was performed by using a filter having an average hole diameter of 0.5 μm and a magnetic layer forming composition was prepared.

Regarding the non-magnetic layer forming composition, each component was dispersed by using a batch type vertical sand mill for 24 hours. As dispersion beads, zirconia beads having a particle diameter of 0.1 mmϕ were used. The obtained dispersion liquid was filtered by using a filter having an average hole diameter of 0.5 μm and a non-magnetic layer forming composition was prepared.

Regarding the back coating layer forming composition, the components excluding the lubricant (stearic acid and butyl stearate), polyisocyanate, and 200.0 parts of cyclohexanone were kneaded by an open kneader and diluted, and was subjected to a dispersion process of 12 passes, with a transverse beads mill dispersion device and zirconia beads having a particle diameter of 1 mmϕ, by setting a bead filling percentage as 80 volume %, a circumferential speed of rotor distal end as 10 m/sec, and a retention time for 1 pass as 2 minutes. After that, the remaining components were added into the obtained dispersion liquid and stirred with a dissolver. The obtained dispersion liquid was filtered with a filter having an average hole diameter of 1.0 μm and a back coating layer forming composition was prepared.

After that, the non-magnetic layer forming composition was applied onto a non-magnetic support made of polyethylene naphthalate having a thickness of 5 μm so that a thickness after the drying becomes 100 nm and was dried, and then, the magnetic layer forming composition was applied thereto so that a thickness after the drying becomes 70 nm.

A homeotropic alignment process was performed by applying a magnetic field having a magnetic field strength of 0.6 T in a vertical direction with respect to a coating surface, while the magnetic layer forming composition is wet, and then, the coating surface was dried to form a magnetic layer. After that, the back coating layer forming composition was applied to the opposite surface of the non-magnetic support so that a thickness after the drying becomes 0.4 μm and was dried.

Then, a surface smoothing treatment (calender process) was performed by a calender configured of only a metal roll, at a speed of 100 m/min, linear pressure of 300 kg/cm (294 kN/m), and a surface temperature of a calender roll of 100° C., and then, the heat treatment was performed in the environment of the atmosphere temperature of 70° C. for 36 hours. After the heat treatment, the non-magnetic support including the magnetic layer, the non-magnetic layer, and the back coating layer was slit to have a width of ½ inches (0.0127 meters), and a magnetic tape was obtained.

The SO₃Na group-containing polyurethane resin having a crosslinked structure included in the magnetic layer was confirmed. The confirmation whether the crosslinked structure of the magnetic layer was performed by adding 0.05 ml of methyl ethyl ketone dropwise on the surface of the magnetic layer of the magnetic tape, wiping the surface of the magnetic layer with a wipe, and visually observing that the component of the magnetic layer is not attached to the wipe.

### Example 2

A magnetic tape was manufactured in the same manner as in Example 1, except that the temperature at the time of adding the ammonia aqueous solution A was changed from 25° C. to 4° C.

### Example 3

A magnetic tape was manufactured in the same manner as in Example 1, except that the temperature at the time of adding the ammonia aqueous solution A was changed from 25° C. to 40° C.

### Example 4

A magnetic tape was manufactured in the same manner as in Example 1, except that the temperature at the time of adding the ammonia aqueous solution A was changed from 25° C. to 60° C.

### Example 5

1 g of the ferromagnetic powder obtained in Example 1 was added to 32 g of a polyvinylpyrrolidone (PVP) aqueous solution having a concentration of 5% by mass. Zirconia (Zr) beads having a diameter of 100 μm was added thereto, the mixture was shaken by a shaker at room temperature for 6 hours, thereby dispersing the ferromagnetic powder in the PVA aqueous solution.

This dispersion liquid was treated for 45 minutes with a centrifugal force of 1,961,330 m/s² (200,000 G) by using a centrifugal separator. The precipitate was washed with pure water and dried at 80° C., thereby obtaining ferromagnetic powder of Example 5.

A magnetic tape was manufactured by the same procedure as that in Example 1, by using the ferromagnetic powder of Example 5.

### Example 6

A magnetic tape was manufactured in the same manner as in Example 5, except that the conditions of the centrifugal separation was changed to 30 minutes with a centrifugal force of 1,961,330 m/s².

### Example 7

A magnetic tape was manufactured in the same manner as in Example 5, except that the conditions of the centrifugal separation was changed to 20 minutes with a centrifugal force of 1,961,330 m/s².

### Example 8

A magnetic tape of Example 8 was obtained in the same manner as in Example 3, except that the amount of the SO₃Na group-containing polyurethane resin was changed so that a mass ratio of the ferromagnetic powder and other components which are not volatilized after the drying (nonvolatile component) (nonvolatile component/ferromagnetic powder) in the magnetic layer which was 0.3, becomes 0.15.

### Example 9

A magnetic tape of Example 9 was obtained in the same manner as in Example 3, except that the amount of the SO₃Na group-containing polyurethane resin was changed so that a mass ratio of the ferromagnetic powder and other components which are not volatilized after the drying (nonvolatile component) (nonvolatile component/ferromagnetic powder) in the magnetic layer which was 0.3, becomes 0.6.

### Example 10

A magnetic tape of Example 10 was obtained in the same manner as in Example 3, except that the amount of the SO₃Na group-containing polyurethane resin was changed so that a mass ratio of the ferromagnetic powder and other components which are not volatilized after the drying (nonvolatile component) (nonvolatile component/ferromagnetic powder) in the magnetic layer which was 0.3, becomes 1.0.

### Example 11

A magnetic tape of Example 11 was obtained in the same manner as in Example 3, except that the amount of the SO₃Na group-containing polyurethane resin was changed so that a mass ratio of the ferromagnetic powder and other components which are not volatilized after the drying (nonvolatile component) (nonvolatile component/ferromagnetic powder) in the magnetic layer which was 0.3, becomes 1.8.

### Example 12

A magnetic tape of Example 12 was obtained in the same manner as in Example 3, except that the film thickness of the magnetic layer which was 70 nm in Example 3 was changed to 40 nm.

### Example 13

A magnetic tape of Example 13 was obtained in the same manner as in Example 3, except that the film thickness of the magnetic layer which was 70 nm in Example 3 was changed to 150 nm.

### Example 14

A magnetic tape of Example 14 was obtained in the same manner as in Example 3, except that the film thickness of the magnetic layer which was 70 nm in Example 3 was changed to 300 nm.

### Comparative Example 1

4.0 g of a 25% by mass ammonia aqueous solution was added to a mixture obtained by dissolving 8.2 g of iron (III) nitrate nonahydrate, 1.2 g of gallium (III) nitrate octahydrate, 187 mg of cobalt (II) nitrate hexahydrate, and 142 mg of titanium (IV) sulfate in 90 g of pure water, while stirring by using a magnetic stirrer, in an atmosphere under the conditions of 40° C., and this solution was stirred for 2 hours. A solution obtained by dissolving 478 mg of citric acid to 4.5 g of water was added thereto, 6.2 g of 10% ammonia aqueous solution was subsequently added thereto, and stirred for 1 hour. The obtained solution was ultrafiltered by a ultrafiltration membrane (cutoff molecular weight of 50,000) until electrical conductivity becomes equal to or smaller than 50 mS/m.

Water was added to the obtained liquid so that a total volume becomes 120 mL, and then, 6.7 g of 25% ammonia was added thereto while stirring at 30° C. 15.8 mL of TEOS was added thereto and continued to stir for 24 hours. After that, a solution obtained by dissolving 2.9 g of ammonium sulfate in 4.5 mL of pure water was added. The precipitated powder was collected by centrifugal separation, washed with pure water, and dried at 80° C., thereby obtaining powder which is a precursor of an epsilon-type iron oxide-based compound.

A magnetic tape of Comparative Example 1 was obtained by setting the procedure of obtaining the ferromagnetic powder from the powder which is a precursor of an epsilon-type iron oxide-based compound, the measurement of the average primary particle diameter of the ferromagnetic powder, and the procedure of manufacturing the magnetic tape to be the same as those in Example 1.

### Comparative Example 2

The ferromagnetic powder was prepared based on examples disclosed in JP5130534B.

Procedure 1 Two kinds of micellar solutions of a micellar solution I and a micellar solution II were prepared.

Preparation of Micellar Solution I

6 mL of pure water, 18.3 mL of n-octane, and 3.7 mL of 1-butanol were put into a flask made of Teflon (registered trademark). 0.0024 mol of iron (III) nitrate nonahydrate and 0.0006 mol of gallium (III) nitrate n-hydrate (component having purity of 99.9% and n of 7 to 9 manufactured by Wako Pure Chemical Industries, Ltd. was used, and quantitative analysis was performed in advance of the use to specify n and calculate the amount to be used) were added thereto and dissolved while fully stirring at room temperature. In addition, the amount of cetyltrimethylammonium bromide as a surfactant was added so that a molar ratio of pure water/surfactant becomes 30, cetyltrimethylammonium bromide was dissolved by stirring, and the micellar solution I was obtained. Regarding the composition used at this time, in a case where a molar ratio of Ga and Fe is expressed as Ga:Fe=x:(2−x), x=0.40.

Preparation of Micellar Solution II

2 mL of 25% ammonia water was mixed with 4 mL of pure water and stirred, and 18.3 mL of n-octane and 3.7 mL of 1-butanol were added thereto and fully stirred. The amount of cetyltrimethylammonium bromide as a surfactant was added to the solution as a surfactant so that a molar ratio of (pure water+moisture in ammonia)/surfactant becomes 30, cetyltrimethylammonium bromide was dissolved, and the micellar solution II was obtained.

Procedure 2

The micellar solution II was added dropwise to the micellar solution I while fully stirring the micellar solution I. After the dropwise addition, the mixed solution was continuously stirred for 30 minutes.

Procedure 3

6.1 mL of tetraethoxysilane was added to the mixed solution while stirring the mixed solution obtained in the procedure 2. This mixed solution was continuously stirred approximately for a day.

Procedure 4

The solution obtained in the procedure 3 was set in a centrifugal separator and centrifugal separation was performed. Precipitate obtained by this process was collected. The collected precipitate was washed several times by using a mixed solution of chloroform and methanol.

Procedure 5

After drying the precipitate obtained in the procedure 4, heat treatment was performed in a furnace in the atmosphere at 1,100° C. for 4 hours.

Procedure 6-1

The heat-treated powder obtained in the procedure 5 was cracked by a mortar made of agate, put into 1 L (liter) of a NaOH aqueous solution having a concentration of 10 mol/L, stirred at a temperature of 70° C. for 24 hours, and a process of removing silica present on the surface of the particle was performed. Then, the powder was filtered and sufficiently washed with water.

Procedure 6-2

The powder washed with water was dispersed in 1 L of pure water, dilute nitric acid was gradually added thereto by monitoring pH while stirring the solution at room temperature, to adjust pH to 2.5 to 3.0, the mixture was stirred for 1 hour, and the dried powder was obtained as ferromagnetic powder. Regarding the dried powder, an average primary particle diameter was measured by the same procedure as that in Example 1.

The procedure of manufacturing the magnetic tape from the ferromagnetic powder was set to be the same as that in Example 1, and a magnetic tape of Comparative Example 2 was obtained.

### Comparative Example 3

The ferromagnetic powder was prepared based on examples disclosed in JP5966064B.

In a 40 L reactor, 2910 g of iron (III) nitrate nonahydrate having purity of 99.5%, 786 g of a Ga (III) nitrate solution having a Ga concentration of 10.3% by mass, 66 g of cobal (II) nitrate hexahydrate having purity of 97%, and 69 g of titanium (IV) sulfate having a Ti concentration of 15.2% by mass were dissolved in pure water 31,369 g, while mechanically stirring with a stirring blade in an atmosphere under the conditions of 40° C. A molar ratio of metal ions in the used solution was Fe:Ga:Co:Ti=1.64:0.27:0.05:0.05. The number in brackets after the reagents represents a valence of the metal element.

1,596 g of ammonia solution having a concentration of 22% by mass was added while mechanically stirring by a stirring blade in the atmosphere at 40° C., and continuously stirred for 2 hours. The solution was cloudy brown liquid in the initial stage of the addition, but this was changed to a clear brown reaction liquid after 2 hours, and pH thereof was 1.73.

Then, 1,684 g of a citric acid having a citric acid concentration of 10% by mass was continuously added under the condition of 40° C. for 1 hour, 2,000 g of an ammonia solution having 10% by mass was added at once to set pH as 8.5, and held while stirring under the condition of a temperature of 40° C. for 1 hour, and crystal of iron oxyhydroxide including a substitution element of a precursor which is an intermediate product was generated (procedure 1). A molar ratio of citric acid with respect to the amount of trivalent ferrous ion of this example is 0.12.

The slurry obtained in the procedure was collected, and washed until electrical conductivity of filtrate becomes 50 mS/m by ultrafiltration membrane, a film having a UF cutoff molecular weight of 50,000. In addition, conductivity of the washed slurry was 100 mS/m (procedure 2).

3,163 g of the washed slurry solution (including 60 g of ε-Fe₂O₃ (partially substitute)) obtained in the procedure 2 was fractionated in 5 L reactor, pure water was added so that the liquid amount becomes 4,000 mL, and 0.8% by mass of ammonia with respect to ε-Fe₂O₃ and 7.0% by mass of tetraethoxysilane with respect to ε-Fe₂O₃ were added while stirring in atmosphere at 30° C. After adding 212.5 g of an ammonia solution having a concentration of 22% by mass, 429 g of tetraethoxysilane was added to the slurry solution for 35 minutes. The solution was continuously stirred approximately for a day, and coated with a silanol derivative generated by hydrolysis. After that, a solution obtained by dissolving 203 g of ammonium sulfate to 300 g of pure water, the obtained solution was washed and solid-liquid separated and was collected as a cake (procedure 3).

After drying the precipitate (precursor coated with gel-like SiO2) obtained in the procedure 3, heat treatment was performed with respect to the dried powder in a furnace in the atmosphere at a temperature of 1,066° C. to 1,079° C. for 4 hours, thereby obtaining ferrous oxide magnetic particle powder coated with silicon oxide. The silanol derivative changes to oxide, in a case of performing heat treatment in the atmosphere (procedure 4).

The heat-treated powder obtained in the procedure 4 was stirred in a 20% by mass NaOH aqueous solution at approximately 70° C. for 24 hours, and a process of removing silicon oxide on the surface of the particle was performed. Then, the slurry was washed until conductivity of the washed slurry becomes 1.5 mS/m by ultrafiltration membrane, a film having a UF cutoff molecular weight of 50,000, and dried, thereby obtaining ferromagnetic powder, and an average primary particle diameter of the ferromagnetic powder was measured by the same procedure as that in Example 1.

The chemical composition of the obtained ferrous oxide magnetic particle powder was substantially the same as the composition at the time of adding. The result of the XRD measurement is not shown, but a crystal structure having some ε-Fe₂O₃ was obtained.

The procedure of manufacturing a magnetic tape from the obtained ferromagnetic powder was set to be the same as that in Example 1, and a magnetic tape of Comparative Example 3 was obtained.

Hc/Hc′ was obtained by the method described above.

Running Durability

Each magnetic tape was caused to run at a linear tester speed of 3 m/sec, and film hardness of the magnetic layer was evaluated as running durability.

After causing a tape having a length of 100 m to run 1,000 passes, a degree of chipping of the surface of the magnetic layer at positions of 20 m, 40 m, 60 m, and 80 m from the end of the magnetic tape was observed with an optical microscope (EclipseLV150 manufactured by Nikon Corporation). The degree of chipping at the four positions was evaluated in the following criteria and ranked.

Evaluation

A: Sliding mark was not observed.

B: light sliding mark is present, but has not been developed into chipping of the surface of the magnetic layer.

C: surface of the magnetic layer is chipped off, but there is no practical problems

D: surface of the magnetic layer is chipped off, there are a large number of positions where the surface of the magnetic layer is peeled off or the magnetic layer was scraped, which are a practical problem.

E: the entire surface of the magnetic layer is scraped and there is a practical problem.

Signal-to-Noise-Ratio (SNR)

A magnetic signal was recorded on each manufactured magnetic tape in a tape longitudinal direction under the following conditions and reproduced with a magnetoresistive (MR) head. A reproduction signal was frequency-analyzed with a spectrum analyzer manufactured by Shibasoku Co., Ltd. and electromagnetic conversion characteristics of the magnetic tape were evaluated with an SNR, by setting a ratio of the output of 300 kfci and noise accumulated in a range of 0 to 600 kfci as the SNR.

Recording and Reproduction Conditions

Recording: recording track width 5 μm
Recording gap 0.17 μm
Head saturated magnetic flux density Bs 1.8 T

Reproduction
Reproduction track width 0.4 μm
Distance between shields (sh-sh distance) 0.08 μm
Recording wavelength: 300 kfci

Evaluation

5: substantially no noise, a signal is excellent, no error is observed, and there is no practical problems.

4: a degree of noise is small, a signal is excellent, and there is no practical problems.

3: noise is observed, but a signal is excellent, and there is no practical problems.

2: a degree of noise is great, a signal is unclear, and there is a practical problem.

1: noise and signal cannot be distinguished or cannot be recorded, and there is a practical problem.

TABLE 1

| | Ferromagnetic | | | | | |
|---|---|---|---|---|---|---|
| | powder | Magnetic layer | Magnetic recording medium | | | |
| | Average | Nonvolatile | | | SNR | Running |
| | primary | component/ | | | (electromagnetic | durability |
| | particle | ferromagnetic | HC′ | | conversion | (film |
| | diameter (nm) | powder | (kA/m) | Hc/Hc′ | characteristic) | hardness) |
| Example 1 | 13.3 | 0.3 | 301 | 0.65 | 3 | C |
| Example 2 | 13.5 | 0.3 | 304 | 0.77 | 3 | C |
| Example 3 | 13.5 | 0.3 | 312 | 0.83 | 4 | B |
| Example 4 | 13.6 | 0.3 | 321 | 0.71 | 3 | C |
| Example 5 | 15.4 | 0.3 | 302 | 0.90 | 5 | B |
| Example 6 | 16.6 | 0.3 | 303 | 0.95 | 5 | A |
| Example 7 | 18.1 | 0.3 | 301 | 0.94 | 5 | A |
| Example 8 | 13.5 | 0.15 | 300 | 0.84 | 3 | C |
| Example 9 | 13.5 | 0.6 | 301 | 0.79 | 3 | A |
| Example 10 | 13.5 | 1.0 | 300 | 0.71 | 3 | A |
| Example 11 | 13.5 | 1.8 | 301 | 0.65 | 3 | B |
| Example 12 | 13.5 | 0.3 | 300 | 0.88 | 3 | C |
| Example 13 | 13.5 | 0.3 | 302 | 0.87 | 4 | B |
| Example 14 | 13.5 | 0.3 | 300 | 0.83 | 3 | B |
| Comparative | 13.6 | 0.3 | 314 | 0.54 | 2 | D |
| Example 1 | | | | | | |
| Comparative | 22.3 | 0.3 | 654 | 0.56 | 2 | D |
| Example 2 | | | | | | |
| Comparative | 16.6 | 0.3 | 261 | 0.54 | 2 | D |
| Example 3 | | | | | | |

From the result of Examples 1 to 14, it is found that, in a case where Hc/Hc′ is 0.6 to 1.0, the SNR of the magnetic recording medium and the running durability of the magnetic layer are excellent.

With respect to this, it is found that, in Comparative Examples 1 to 3 in which Hc/Hc′ is smaller than 0.6, the SNR of the magnetic recording medium and the running durability of the magnetic layer are poor.

The magnetic recording medium of this disclosure can be preferably used for a magnetic tape and the like having excellent running durability.

What is claimed is:

1. A magnetic recording medium, comprising:
a non-magnetic support; and
a magnetic layer that is provided on the non-magnetic support and that comprises a ferromagnetic powder and a binding agent, the ferromagnetic powder comprising at least one epsilon-type iron oxide compound selected from the group consisting of ε-Fe₂O₃ and a compound represented by the following Formula (1),
wherein a value of a magnetic field Hc with respect to a magnetic field Hc′ is from 0.6 to 1.0, and Hc′ satisfies the following Expression (II),
wherein the magnetic field Hc′ is a magnetic field when the value of the following Expression (I) is zero, wherein a magnetization M, which is obtained by a magnetic field-magnetization curve obtained by measurement at a maximum applied magnetic field of 359 kA/m, a temperature of 296 K, and a magnetic field sweeping speed of 1.994 kA/m/s, is subjected to a second derivative with respect to an applied magnetic field H, and wherein the magnetic field Hc is a magnetic field when the magnetization is zero in the magnetic field-magnetization curve:
d²M/dH² Expression (I)
119 kA/m<Hc′<2380 kA/m Expression (II)
ε-AₐFe₂₋ₐO₃ (1)
wherein, in Formula (1), A represents at least one metal element other than Fe, and a satisfies a relationship of 0<a<2.

2. The magnetic recording medium according to claim 1, wherein the binding agent comprises a binding agent having a crosslinked structure.

3. The magnetic recording medium according to claim 1, wherein a value of Hc with respect to Hc′ is from 0.65 to 1.0.

4. The magnetic recording medium according to claim 1, wherein a value of Hc with respect to Hc′ is from 0.71 to 1.0.

5. The magnetic recording medium according to claim 1, wherein a content of the binding agent is 5 parts by mass to 30 parts by mass with respect to 100 parts by mass of the ferromagnetic powder.

6. The magnetic recording medium according to claim 1, wherein a mass ratio of mass of a nonvolatile component with respect to mass of the ferromagnetic powder in the magnetic layer is from 0.15 to 1.8.

7. The magnetic recording medium according to claim 1, wherein a thickness of the magnetic layer is 10 nm to 350 nm.

8. The magnetic recording medium according to claim 1, wherein A in Formula (1) is at least one metal element selected from the group consisting of Ga, Al, In, Nb, Co, Zn, Ni, Mn, Ti, and Sn.

9. The magnetic recording medium according to claim 8, wherein the compound represented by Formula (1) comprises Ga, and an atomic composition percentage of Ga atoms is 5 atom % to 50 atom % with respect to Fe atoms.
